(19) United States
(12) Patent Application Publication
(10) Pub. No.: US 2010/0199501 A1
(43) Pub. Date: Aug. 12, 2010

(54) POWER ASSISTED UTILITY KNIFE

(75) Inventor: Hector Ray Hernandez, Fullerton, CA (US)

Correspondence Address: FULWIDER PATTON LLP, HOWARD HUGHES CENTER, 6060 CENTER DRIVE, TENTH FLOOR, LOS ANGELES, CA, 90045, US

(73) Assignee: ALLTRADE TOOLS LLC, Long Beach, CA (US)

(21) Appl. No.: 12/369,599

(22) Filed: Feb. 11, 2009

(51) Int. Cl. B26B 7/00; B26B 1/08; B26B 5/00

(52) U.S. Cl. 30/162; 30/277.4; 30/335

(57) ABSTRACT

A power assisted utility knife is described, having a blade that may be oscillated back and forth by a motor. The utility knife further includes structure that permits the blade to be withdrawn into the knife for safekeeping, and to be extended outside the knife sufficiently far to permit an old blade with a dull edge to be removed, and a fresh blade to be inserted.

### BACKGROUND

This application relates to utility knives in general. Specifically, it relates to a power assisted utility knife.

Utility knives are well known, and are used for many different functions. However, some functions are less than adequately served by utility knives. For example, cutting dry wall, commonly known as “sheet rock,” is one function to which a user may typically apply a utility knife. Generally, a user achieves the cleanest dry wall cut when the cutting action used is a slicing action, that is, a single long slice taken by a continuous hand movement from one end of the dry wall to the other. However, a problem that frequently arises when slicing dry wall with a utility knife is that the blade may become trapped in the cut during the slicing action, and this may require the user to vigorously wiggle the blade, or to manually introduce a sawing action, before the slicing action may be started again. Additionally, the user may be obliged to manually prize the cut open, and then commence a sawing action to get the slicing action started again. These interruptions introduce a raged edge to the finished cut, and are undesirable.

A further problem encountered in the art of utility knives is the difficulty with which the blade of a utility knife may be attached to a retracting block inside the knife for keeping the blade safe from accidental injury to the user. These difficulties are compounded where a motor may be introduced for providing a power assisted utility knife.

Accordingly, there is a need in the art for a utility knife that tends to prevent a blade from becoming trapped during a cutting action, and one which also provides ease of blade exchange in such a knife. The present invention addresses these and other needs.

### SUMMARY OF THE INVENTION

According to a preferred embodiment of the invention, there is described a power assisted utility knife that is light weight, simple to manufacture, and that overcomes shortcomings in the prior art. In a first preferred embodiment, the invention comprises a housing defining an internal cavity. A motor is positioned within the cavity, and the motor includes an axially rotatable drive shaft. A battery and a switch are also positioned within the cavity for electively energizing the motor and rotating the drive shaft. A camming annulus is fixed to the drive shaft, the camming annulus being offset from perpendicular to the drive shaft axis. A blade block is provided for holding a blade, the blade block being positioned within the cavity and configured in relation to the housing to slide forwards and backwards within the cavity. A coupling rod is provided for connecting the blade block with the motor. At a first end of the rod, the rod is releasably engaged with the blade block, and at a second end of the rod, the rod has a forward and a rearward cam follower, each cam follower being positioned adjacent a forward and a rearward portion of the camming annulus respectively, whereby rotation of the drive shaft causes the camming annulus to apply an oscillating forward and backward force to the coupling rod via the cam followers, thereby oscillating the blade block forward and backward. The blade block includes a set screw configured to electively engage, and disengage, the blade block with the coupling rod, whereby when the set screw is in an engaging position the blade block is prevented from movement independent of the coupling rod, and when the set screw is in an disengaging position the blade block is slidable in relation to the coupling rod, whereby when the motor is unactivated, the blade block may be electively either retracted into the housing or protruded from the housing.

In a further aspect of the invention, the housing may define an elongate slot through which a portion of the set screw extends to the exterior of the housing for enabling movement of the block within the housing by manual operation of the set screw. Preferably, the slot extends rearwardly to an extent that is sufficient to permit a blade attached to the block to be completely withdrawn into the housing by rearwardly retracting the set screw. Further preferably, the slot extends forwardly to an extent that is sufficient to permit a blade attached to the block to be extended outside the housing by forwardly advancing the set screw, such that an old blade may be removed from the block and a fresh blade may be installed on the block.

In further desirable aspects of the invention, the block may include a positive detent, and the blade may include a negative detent configured to receive the positive detent for holding the blade, and wherein the positive and negative detents may be disengaged from each other to release the blade when the block is extended forwardly outside the housing. Moreover, the block may include a hollow portion configured to slideably and releasably receive a forward end of the coupling rod. Also, the coupling rod preferably defines at least two receiving holes for receiving the set screw, namely, a forward receiving hole for permitting the set screw to hold the block with the blade in a protruding position for using the knife, and a rearward receiving hole for permitting the set screw to hold the block with the blade in a position retracted within the housing for safety.

In a further facet of the invention, the invention is a power assisted utility knife, comprising a housing defining an internal cavity, a motor positioned within the cavity, the motor including an axially rotatable drive shaft, and a battery and a switch positioned within the cavity for electively energizing the motor and rotating the drive shaft. A camming surface is fixed to the drive shaft. A block is provided for holding a blade, the block being positioned within the cavity and configured in relation to the housing to slide forwards and backwards within the cavity. A coupling rod is releasably engaged with the blade block, and the couplind rod has a cam follower positioned adjacent the camming surface, whereby rotation of the drive shaft causes the camming surface to apply an oscillating forward and backward motion to the blade block via the coupling rod. Desirably, the blade block is electively engagable with, and disengeable from, the coupling rod, such that when the blade block is engaged with the coupling rod the blade block is prevented from movement independent of the coupling rod, and when the blade block is disengaged from the coupling rod it is slideable in relation to the coupling rod, whereby when the motor is unactivated, the blade block may be electively either retracted into the housing or protruded from the housing.

In a further aspect, the housing defines an elongate slot through which a portion of the blade block extends to the exterior of the housing thereby enabling movement of the block within the housing by manual operation. The slot may extend rearwardly to an extent sufficient to permit a blade, attached to the block, to be completely withdrawn into the housing by rearwardly retracting the block; and the slot may also extend forwardly to an extent sufficient to permit the block to be extended outside the housing by forwardly advancing the block, and also sufficient to allow a blade to be removed from the block and a new blade to be installed on the block. The housing of the knife may include an upper rail and a lower rail for guiding the sliding motion of the guide block within the cavity.

These and other advantages of the invention will become more apparent from the following detailed description thereof and the accompanying exemplary drawings.

### BRIEF DESCRIPTION OF THE DRAWINGS

FIG. 1 shows a perspective view of a utility knife having features of the present invention.

FIG. 2 shows a side elevational fragmented view of the utility knife of FIG. 1.

FIG. 3 shows a side elevational exploded view of the utility knife of FIG. 1.

FIG. 4 shows a perspective, exploded view of a detailed aspect of the utility knife of FIG. 1.

### DETAILED DESCRIPTION OF THE PREFERRED EMBODIMENTS

With reference to the Figures, there is described a preferred embodiment of a power assisted utility knife of the present invention, generally identified by the numeral 10.

In a preferred aspect, the utility knife 10 includes a housing comprising two mirror image halves, a left half 12, and a right half 14, held together by screws or detents (not shown), to form a hand holdable utility knife 10 with a forward end 16 and a rearward end 18. The left and right halves 12, 14 define a central cavity 19 configured to receive and house working components of the utility knife.

Housed within the cavity 19 is a closed cell battery 32, preferably a 9 volt battery of generally rectangular configuration, capable of powering a motor 30 which is also housed within the cavity and preferably positioned forward of the battery. A removable door 25 may enclose the battery and permit its removal and exchange. The motor has an axially rotating output shaft 34, preferably extending forwardly along the length of the utility knife 10. A switch 33 is positioned on the external surface of the knife housing so that a user may electively switch the motor on and off.

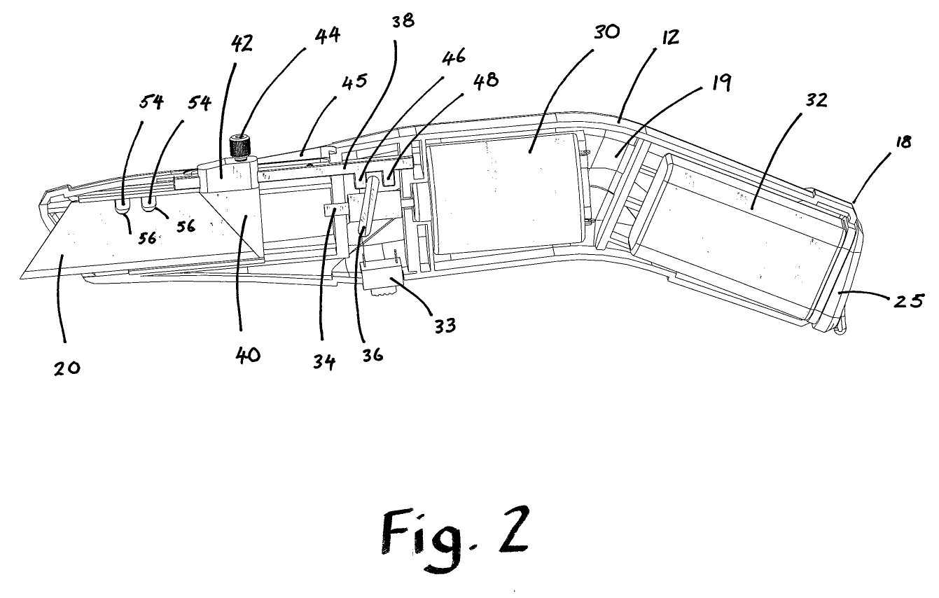

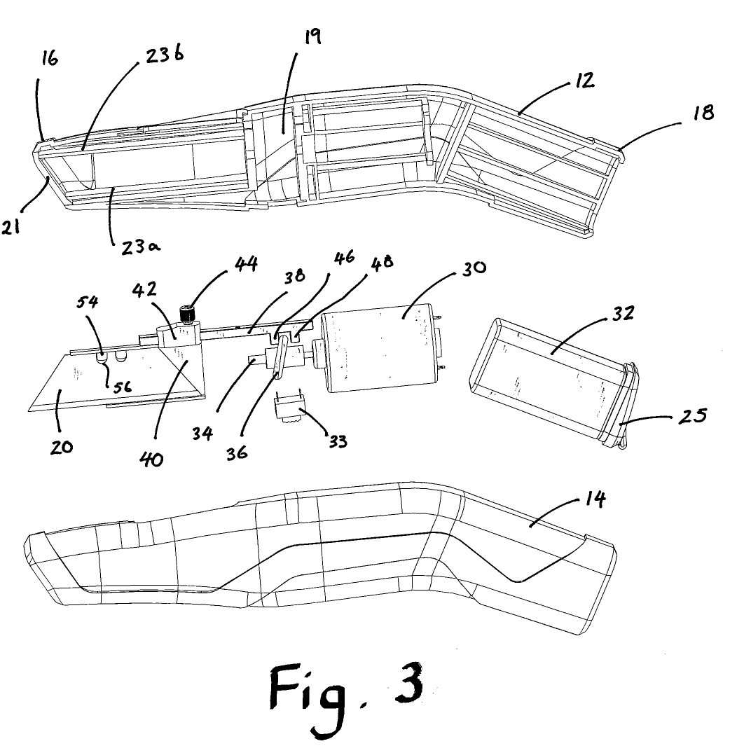

At the forward end 16 of the knife 10, a blade 20 is positioned to extend from a slot 21 in the housing. In a preferred aspect, the blade 20 is held by a blade block 40 that is slidable within the cavity 19. To facilitate such sliding, a lower rail 23a and an upper rail 23b (FIG. 3) may be provided to guide the block as it slides forwardly and rearwardly within the cavity 19. Preferably, the blade 20 defines at least one notch or negative detent 56, adapted to receive a positive detent 54 on the block (best seen, FIG. 2), whereby the blade is held by the block while the block is within the confines of the housing. The housing is configured to prevent the blade from moving laterally while the block is within the housing, thus preventing the negative detents 56 from releasing the positive detents 54 on the block, and thus maintaining conjoined movement of the blade and block within the housing.

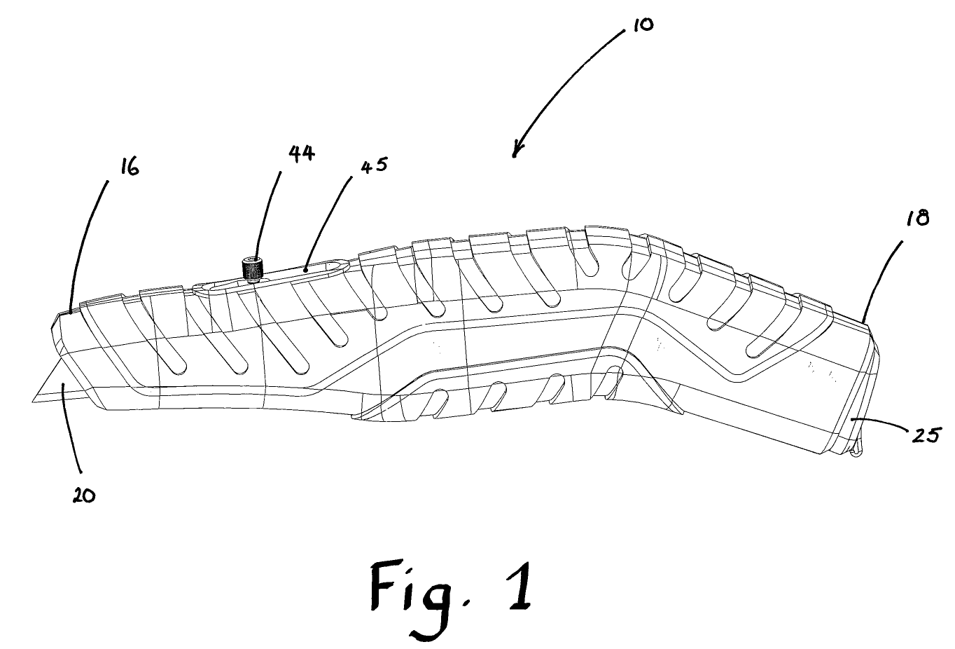

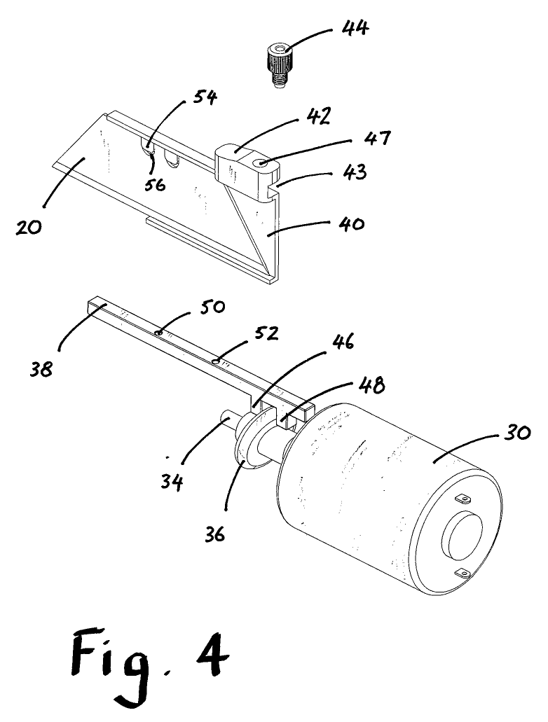

In order to couple the blade 20 with the action of the motor, a coupling rod 38 is provided. At a rear end of the block 40, a connector element 42 is provided, the connector element having a hollow portion 43 (best seen FIG. 4) sized to receive a forward end of the coupling rod 38, as seen in FIGS. 2 and 3. A manually operable set screw 44 is provided to secure the coupling rod 38 to the connector element 42 (and hence the block 40). The set screw 44 is configured to protrude from the knife housing (as seen FIG. 1) and is conveniently positioned so that a user may manually tighten or loosen it within receiving holes 50, 52 in the coupling rod 38. Preferably, the set screw is threadably engaged with a mating threaded hole 47 (FIG. 4) in the connector element, but a spring operated connection (not shown) may also be used to removably lock a terminal end of the set screw in one of the receiving holes 50, 52. The knife 10 includes an elongate slot 45 configured so that a user may unloosen the set screw 44 to axially disengage it from the block 40, and then slide the set screw 4 forwards or rearwards in the slot 45. This action will extend or withdraw the blade 20, and if necessary the block 40, out of and into the housing. Once the block is in a desired position, the user may tighten the set screw 44 onto the coupling rod once again to secure the block 40 against accidental movement relative to the housing and secure the blade 20 from accident.

The rearward end of the coupling rod 38 includes two cam followers, a forward cam follower 46 and a rearward cam follower 48. Preferably, these cam followers may extend vertically, and are positioned to extend adjacent to a forward and a rearward side of a camming annulus 36 that is attached to a forward end of the motor's output shaft 34. The camming annulus is set at an angle to the rotating axis of the output shaft, so that, when the output shaft rotates, an upper portion of the annulus 36 that is adjacent to the two cam followers 46 and 48 oscillates backwards and forwards. This backward and forward oscillating motion is imparted to the coupling rod 38 via the cam followers, so that the coupling rod oscillates backwards and forwards when the output shaft rotates.

It will be appreciated that, when the coupling rod 38 oscillates backwards and forwards, the blade block 40 (holding the blade 20) will also oscillate backwards and forwards when the set screw is holding the block fixed to the coupling rod. Thus, if the block is set to be connected via the set screw 40 to the forward end of the coupling rod 38, the blade extending out of the housing from the forward slot 21 can be made to oscillate, or vibrate, backwards and forwards by turning on the motor via switch 33. Desirably, sufficient space is provided within the cavity 19 so that, when the blade is in a retracted position, the blade may still oscillate back and forth if the switch is inadvertently activated. This feature, although not presenting any danger of accidental injury, will prevent the motor from burning out, which might otherwise occur if the blade were prevented from moving at all in the retracted position.

In another aspect of the invention, the length of the upper slot 45 in the knife housing is sufficiently long in the forward direction that the set screw 44 may be manually set to disengage the block 40 from the coupling rod 38, whereupon the set screw, along with block, may be manually slid forward over the forward end of the coupling rod 38 to expose a substantial portion of the block outside the housing, and specifically exposing the positive detents 54 on the block and the negative detents 56 on the blade 20. In this exposed position, a blade with dulled edge may be manually removed from its position in the block, and a fresh blade inserted in its place. Once the fresh blade is in position on the block, the set screw 44 may be withdrawn rearwardly in upper slot 45, where the set screw may be engaged with either forward receiving hole 50, or the rearward receiving hole 52, as desired and depending on whether the knife is to be used or stored.

Thus, in use, the power assisted utility knife 10 may be operated in the following way. If the knife blade is in the retracted, or storage, position the user first loosens set screw 40 to disengage the blade block 40 from the coupling rod 38 where the set screw is positioned within rearward receiving hole 52. He then slides the set screw 40 forwards along the upper slot 45, until the blade 20 protrudes from the forward slot 21, whereupon the user may tighten the set screw in forward receiving hole 50 to secure the blade block 40 to the coupling rod 38 in an intermediate position for use. At this stage, the user may activate the motor by depressing the external switch 33. The activated motor will rotate the camming annulus 36 via the output shaft 34, and the camming annulus will in turn drive the cam followers 46, 48 backwards and forwards, which in turn will compel the blade 20 to oscillate backwards and forwards via the coupling rod 38 and block 40. At this stage, the user may commence a slicing action on a piece of sheet rock or other material. The oscillating action of the blade will tend to inhibit the blade becoming stuck in the cut introduced into the material. This advantageous result tends to solve the problem identified above, of the blade becoming stuck in a cut, causing the user to interrupt his slicing action that may result in a raged cut edge and inconvenience and delay to the user. Once the user has completed his slicing action, he may deactivate the motor via the switch, and then loosen set screw 44 to disengage it from its position in receiving hole 50, slide the set screw and block rearwardly along the coupling rod 38, and then engage the set screw in rearward receiving hole 52 so that the blade is retracted into the housing for safekeeping.

Finally, when the user wishes to exchange a dull blade for a fresh one, he loosens set screw 4 from whatever position it is located, either within receiving hole 50 or 52. He then slides the set screw forwardly, all the way along the upper slot 45 until the block itself protrudes from the housing in a forwardly position. In this position the positive 54 and negative 56 detents of the block and blade are exposed, and the user is able to manually remove the dull edged blade, and reinstall a fresh one by firstly extending a rearward edge of the new blade into the forward slot 21, and then dropping the blade onto the block so that the detents engage. Once the blade is aligned with the longitudinal axis of the knife, the user may grasp the set screw 44 and withdraw the blade into the knife, and may choose to set the screw in receiving hole 50 or receiving hole 52, depending on whether he wishes to use the knife, or store it.

Thus, the structure described permits a user to deploy a power assisted utility knife on a project with very little complexity, and also to position the blade in one of three distinct positions, namely storage (rearwardly) position, user (intermediate) position, and blade exchange (forwardly) position. These three allowable positions in combination with the structure enabling power assisted use provide an advantageous device that overcomes shortcomings in the art.

It will be apparent from the foregoing that, while particular forms of the invention have been illustrated and described, various modifications can be made without parting from the scope of the invention which is set forth in the claims.

We claim:

1. A power assisted utility knife, comprising:
a housing defining an internal cavity;
a motor positioned within the cavity, the motor including an axially rotatable drive shaft;
a battery and a switch positioned within the cavity for electively energizing the motor and rotating the drive shaft;
a camming annulus fixed to the drive shaft, the camming annulus being offset from perpendicular to the drive shaft axis;
a blade block for holding a blade, the blade block being positioned within the cavity and configured in relation to the housing to slide forwards and backwards within the cavity;
a coupling rod, at a first end of the rod releasably engaged with the blade block, and at a second end of the rod having a forward and a rearward cam follower, each cam follower being positioned adjacent a forward and a rearward portion of the camming annulus respectively, whereby rotation of the drive shaft causes the camming annulus to apply an oscillating forward and backward force to the coupling rod via the cam followers, thereby oscillating the blade block forward and backward;
wherein, the blade block includes a set screw configured to electively engage, and disengage, the blade block with the coupling rod, whereby when the set screw is in an engaging position the blade block is prevented from movement independent of the coupling rod, and when the set screw is in an disengaging position the blade block is slidable in relation to the coupling rod, whereby when the motor is unactivated, the blade block may be electively either retracted into the housing or protruded from the housing.

2. The power assisted utility knife of claim 1, wherein the housing defines an elongate slot through which a portion of the set screw extends to the exterior of the housing for enabling movement of the block within the housing by manual operation of the set screw.

3. The power assisted utility knife of claim 2, wherein the slot extends rearwardly to an extent that is sufficient to permit a blade attached to the block to be completely withdrawn into the housing by rearwardly retracting the set screw.

4. The power assisted utility knife of claim 2, wherein the slot extends forwardly to an extent that is sufficient to permit a blade attached to the block to be extended outside the housing by forwardly advancing the set screw, such that an old blade may be removed from the block and a fresh blade may be installed on the block.

5. The power assisted knife of claim 4, wherein the block includes a positive detent, and the blade includes a negative detent configured to receive the positive detent for holding the blade, and wherein the positive and negative detents may be disengaged from each other to release the blade when the block is extended forwardly outside the housing.

6. The power assisted utility knife of claim 1, wherein the block includes a hollow portion configured to slideably and releasably receive a forward end of the coupling rod.

7. The power assisted utility knife of claim 1, wherein the housing includes an upper rail and a lower rail for guiding the sliding motion of the guide block within the cavity.

8. The power assisted utility knife of claim 1, wherein the coupling rod defines a forward receiving hole for permitting the set screw to hold the block with the blade in a protruding position for using the knife, and a rearward receiving hole for permitting the set screw to hold the block with the blade in a position retracted within the housing for safety.

9. A power assisted utility knife, comprising:
a housing defining an internal cavity;
a motor positioned within the cavity, the motor including an axially rotatable drive shaft;
a battery and a switch positioned within the cavity for electively energizing the motor and rotating the drive shaft;
a camming surface fixed to the drive shaft;
a block for holding a blade, the block being positioned within the cavity and configured in relation to the housing to slide forwards and backwards within the cavity;
a coupling rod releasably engaged with the blade block and having a cam follower positioned adjacent the camming surface, whereby rotation of the drive shaft causes the camming surface to apply an oscillating forward and backward motion to the blade block;
wherein, the blade block is electively engagable with, and disengeable from, the coupling rod, such that when the blade block is engaged with the coupling rod the blade block is prevented from movement independent of the coupling rod, and when the blade block is disengaged from the coupling rod it is slideable in relation to the coupling rod, whereby when the motor is unactivated, the blade block may be electively either retracted into the housing or protruded from the housing.

10. The power assisted utility knife of claim 9, wherein the housing defines an elongate slot through which a portion of the blade block extends to the exterior of the housing thereby enabling movement of the block within the housing by manual operation.

11. The power assisted utility knife of claim 10, wherein the slot extends rearwardly to an extent sufficient to permit a blade, attached to the block, to be completely withdrawn into the housing by rearwardly retracting the block.

12. The power assisted utility knife of claim 10, wherein the slot extends forwardly to an extent sufficient to permit the block to be extended outside the housing by forwardly advancing the block, and also sufficient to allow a blade to be removed from the block and a new blade to be installed on the block.

13. The power assisted knife of claim 12, wherein the block includes a positive detent, and the blade includes a negative detent configured to receive the positive detent for holding the blade, and wherein the positive and negative detents may be disengaged from each other when the block is extended forwardly outside the housing.

14. The power assisted utility knife of claim 9, wherein the block includes a hollow portion configured to releasably receive a forward end of the coupling rod.

15. The power assisted utility knife of claim 9, wherein the housing includes an upper rail and a lower rail for guiding the sliding motion of the guide block within the cavity.
